(19) United States
(12) Patent Application Publication
(10) Pub. No.: US 2018/0124540 A1
(43) Pub. Date: May 3, 2018

(54) PROJECTION-BASED AUDIO CODING

(71) Applicant: GOOGLE LLC, Mountain View, CA (US)

(72) Inventors: Jan SKOGLUND, San Francisco, CA (US); Michael GRACZYK, Palo Alto, CA (US)

(21) Appl. No.: 15/799,980

(22) Filed: Oct. 31, 2017

Related U.S. Application Data
(60) Provisional application No. 62/415,189, filed on Oct. 31, 2016.

(51) Int. Cl. H04S 3/02; G10L 19/008; H04S 7/00

(52) U.S. Cl. CPC H04S 3/02; H04S 2420/11; H04S 7/302; G10L 19/008

(57) ABSTRACT

Techniques of performing ambisonic coding involve coupling channels of a high-order ambisonics (HOA) signal using a projection matrix based on positions of a set of loudspeakers on a unit sphere to form a projected HOA signal. Each pair of components of the projected HOA signal may then be encoded into a stereo format. In some arrangements, the projection matrix may be based on a decoding or demixing matrix that is in turn based on spherical harmonics evaluated at specified loudspeaker positions. In this way, the encoding efficiency (e.g., bitrate for a given sound quality) is improved over the conventional approaches to performing ambisonic coding.

### CROSS-REFERENCE TO RELATED APPLICATIONS

This application claims priority to, and is a continuation of, U.S. Patent Application No. 62/415,189, filed on Oct. 31, 2016, entitled “PROJECTION-BASED AUDIO CODING”, the disclosure of which is incorporated by reference herein in its entirety.

### TECHNICAL FIELD

This description relates to binaural rendering of sound fields in virtual reality (VR) and similar environments.

### BACKGROUND

Ambisonics is a full-sphere surround sound technique: in addition to the horizontal plane, it covers sound sources above and below the listener. Unlike other multichannel surround formats, its transmission channels do not carry speaker signals. Instead, they contain a speaker-independent representation of a sound field called B-format, which is then decoded to the listener's speaker setup. This extra step allows the producer to think in terms of source directions rather than loudspeaker positions, and offers the listener a considerable degree of flexibility as to the layout and number of speakers used for playback. In ambisonics, an array of virtual loudspeakers surrounding a listener generates a sound field by decoding a sound file encoded in a scheme known as B-format from a sound source that is isotropically recorded. The sound field generated at the array of virtual loudspeakers can reproduce the effect of the sound source from any vantage point relative to the listener. Such decoding can be used in the delivery of audio through headphone speakers in Virtual Reality (VR) systems. Binaurally rendered ambisonics refers to the creation of virtual loudspeakers which combine to provide a pair of signals to left and right headphone speakers.

### SUMMARY

In one general aspect, a method can include receiving, by processing circuitry of a server computing device configured to encode high-order ambisonic (HOA) audio data having a specified number of channels, loudspeaker data indicating positions of a plurality of loudspeakers with respect to a listener. The method can also include generating, by the processing circuitry, projection matrix data representing a projection matrix, the projection matrix being based on the loudspeaker data and the specified number of channels. The method can further include receiving, by the processing circuitry, HOA audio data having the specified number of channels. The method can further include performing, by the processing circuitry, a projection operation on the HOA audio data and the projection matrix data to produce a projected HOA signal, the projected HOA signal having a plurality of components. The method can further include arranging, by the processing circuitry, pairs of components of the projected HOA signal into coupled streams in a stereo format.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates an example electronic environment for implementing improved techniques described herein.

FIG. 2 is a flow chart that illustrates an example method of performing the improved techniques within the electronic environment shown in FIG. 1.

FIG. 3 is a diagram that illustrates an example format of a file used to decode stereo streams into ambisonic signals.

FIG. 4 illustrates an example of a computer device and a mobile computer device that can be used with circuits described here.

### DETAILED DESCRIPTION

In a conventional ambisonic coding approaches, the producer may code each ambisonic channel (e.g., W, X, Y, Z in first-order ambisonics) as an independent, decoupled Opus stream. For first-order ambisonics, it may be beneficial to use a non-uniform bitrate allocation between the channels, e.g., by giving more bits to the omnidirectional channel W than to the directional channels X, Y, and Z. Although this direct uncoupled compression method works well for first order, it does not generalize well to higher orders because each channel would be coded at a relatively low rate independently. The conventional ambisonic coding technique, which does not couple the channels, does not take advantage of many useful features in Opus such as coupled stereo mode, time-varying bitrate allocation, or surround masking.

In accordance with the implementations described herein and in contrast with the above-described conventional approaches to performing ambisonic coding, improved techniques involve coupling channels of a HOA signal using a projection matrix based on positions of a set of loudspeakers on a unit sphere to form a projected HOA signal. Each pair of components of the projected HOA signal may then be encoded into a stereo format. In some arrangements, the projection matrix may be based on a decoding or demixing matrix that is in turn based on spherical harmonics evaluated at specified loudspeaker positions. In this way, the encoding efficiency (e.g., bitrate for a given sound quality) is improved over the conventional approaches to performing ambisonic coding.

For the purposes of this document, stereo sound is taken to be a sound reproduction that uses two or more independent audio channels through a configuration of two or more loudspeakers (or stereo headphones). Thus the term “stereo” applies to quadraphonic and surround-sound systems as well as two-channel, two-speaker systems.

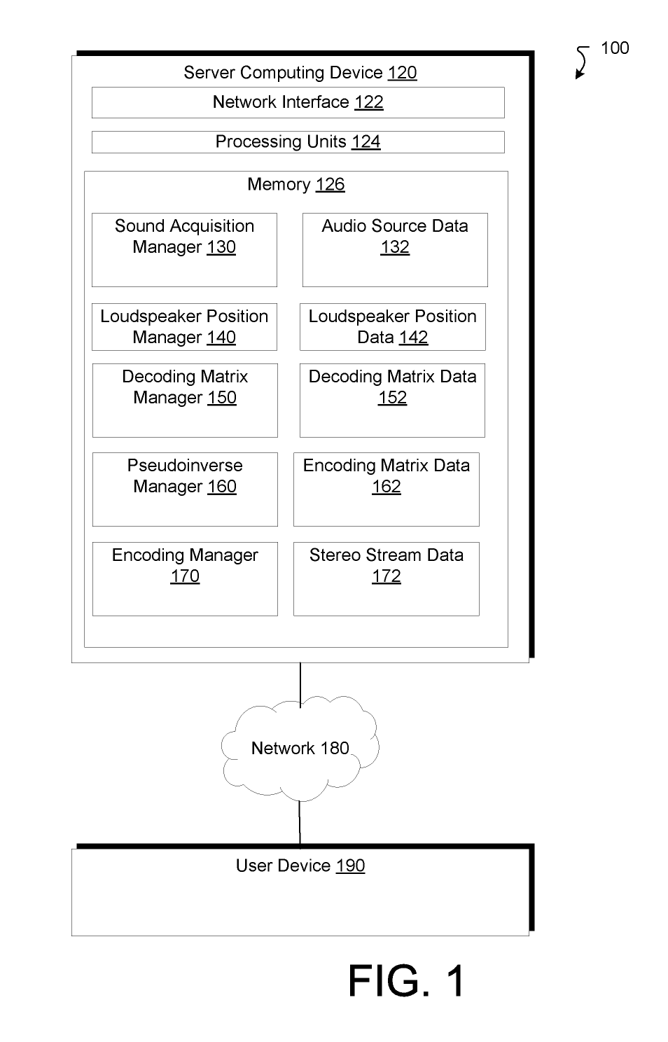

FIG. 1 is a diagram that illustrates an example electronic environment 100 in which the above-described improved techniques may be implemented. As shown, in FIG. 1, the example electronic environment 100 includes a server computing device 120, a network 180, and a user device 190.

The server computing device 120 is configured to encode high-order ambisonic (HOA) audio data having a specified number of channels. The server computing device 120 includes a network interface 122, one or more processing units 124, and memory 126. The network interface 122 includes, for example, Ethernet adaptors, Token Ring adaptors, and the like, for converting electronic and/or optical signals received from the network 170 to electronic form for use by the point cloud compression computer 120. The set of processing units 124 include one or more processing chips and/or assemblies. The memory 126 includes both volatile memory (e.g., RAM) and non-volatile memory, such as one or more ROMs, disk drives, solid state drives, and the like. The set of processing units 124 and the memory 126 together form control circuitry, which is configured and arranged to carry out various methods and functions as described herein.

In some embodiments, one or more of the components of the server computing device 120 can be, or can include processors (e.g., processing units 124) configured to process instructions stored in the memory 126. Examples of such instructions as depicted in FIG. 1 include a sound acquisition manager 130, a loudspeaker position manager 140, a decoding matrix manager 150, a pseudoinverse manager 160, and an encoding manager 170. Further, as illustrated in FIG. 1, the memory 126 is configured to store various data, which is described with respect to the respective managers that use such data.

The sound acquisition manager 130 is configured to acquire sound data 132 from various sources. For example, the sound acquisition manager 130 may the sound data 132 from an optical drive or over the network interface 122. Once it acquires the sound data 132, the sound acquisition manager is also configured to store the sound data 132 in memory 126. In some implementations, the sound acquisition manager 130 streams the sound data 132 over the network interface 122.

The sound data 132 includes position data for each actual source. In this case, the position data for an actual source may take the form of a triplet (r, θ, φ), where r is the distance between the actual source and the center of the sphere, θ is an elevation angle, and φ is an azimuth angle.

In some implementations, the sound data 132 is encoded in B-format, or first-order ambisonics with four components, or ambisonic channels. In other implementations, the sound data 132 is encoded in higher-order ambisonics, e.g., to order K. In this case, there will be (K+1)² ambisonic channels.

The loudspeaker position manager 140 is configured to produce, for each actual audio source, loudspeaker position data 142 indicating positions of virtual or real loudspeakers on the sphere producing sound from that actual audio source. In some implementations, the loudspeakers are arranged at the same distance from the listener. In this case, the loudspeaker positions 142 may be expressed as angular coordinates (θ, φ) n the unit sphere. In some arrangements, the loudspeaker position manager 140 is configured to generate the loudspeaker positions 142 according to a spherical packing over the unit sphere, e.g., such that the loudspeaker positions 142 maximize the minimum distance between any pair of loudspeaker positions 142. In some arrangements, the loudspeaker position manager 140 is configured to generate loudspeaker positions 142 uniformly over the unit sphere.

The decoding manager 150 is configured to generate decoding matrix data 152 representing a decoding matrix used to convert stereo-encoded audio streams into ambisonic signals. Along these lines, the decoding manager 150 is configured to convert each encoded stereo stream into pairs of components of a projected signal vector. The decoding manager 150 then multiplies this projected signal vector by the decoding matrix 152 to produce the ambisonic signals.

In some implementations, the pairs of streams represent virtual loudspeakers. For example, the pairs of streams may be constructed from adjacent pairs of virtual loudspeakers. In this case, such pairs of streams may take advantage of the useful features in Opus encoding.

In some implementations, the server computing device 120 is configured to send the decoding matrix data 152 to the user device 190 over the network 180 in response to a request from the user device 190 for ambisonic audio. For example, the user device 190 may run a browser in which a 360-degree video file is playing; typically, such a 360-degree video file plays a HOA ambisonic audio file. In this case, the server computing device 120 may send encoded stereo-formatted audio data (i.e., Opus encoded in an Ogg format) and the decoding matrix data 152 to the user device 190. The user device 190 may then decode the encoded stereo-formatted audio data using the decoded matrix data 152.

The pseudoinverse manager 160 is configured to perform a Moore-Penrose pseudoinverse operation on the decoding matrix data 152 to produce encoding matrix data 162 representing an encoding matrix.

The encoding manager 170 is configured to produce encoded stereo stream data 172 from ambisonic signals, e.g., audio source data 132 using the encoding matrix data 162. The encoding manager 170 multiplies the ambisonic signals by the encoding matrix 162 to produce the projected signal vector. In some implementations, the encoding manager 170 then produces the encoded stereo signals from the projected signal vector by arranging components of the projected signal vector into an array of component pairs. The encoding manager 170 is configured to arrange the components into pairs whose components are as similar as possible, i.e., for maximum coding efficiency. In some implementations, the encoding manager 170 arranges the components into pairs of consecutive components.

As discussed above, in some implementations the encoding manager 170 is configured to employ Opus encoding. Nevertheless, other types of encoding are possible. For example, in some implementations, the encoding manager 170 is configured to employ MP3 encoding.

In an example implementation of the improved techniques, let s(t)=[s₁(t), s₂(t), . . . , s_{N}(t)] denote an N-dimensional row vector containing an ambisonic signal of order K at time t. The number of ambisonic channels are given by the relation

N=(K+1)².

The ambisonic signal s(t) is first projected into an even-numbered set of M channels using an N-by-M matrix E such that

x(t)=s(t)E,

where x(t) is an M-dimensional row vector. Consecutive pair of signals in the vector x(t) are then formed into M/2 separate streams yᵢ(t), such that

$$\begin{matrix}{y}_{1} ( t ) = [ {x}_{1} ( t ) , {x}_{2} ( t ) ] , \\ … \\ {y}_{M / 2} ( t ) = [ {x}_{M - 1} ( t ) , {x}_{M} ( t ) ] .\end{matrix}$$

Each yᵢ(t) is then encoded as a coupled stereo stream with Opus using bit rate rᵢ(t), and the total bit rate is

$${\sum }_{i} {r}_{i} ( t ) = R .$$

The decoder outputs M/2 2-dimensional vectors \tilde{y}ᵢ(t) which are concatenated into one N-dimensional row vector \tilde{x}(t). The final decoded ambisonic signal is obtained by multiplication with an N-by-M decoding projection matrix D

\tilde{s}(t)=\tilde{x}(t)D.

Note that the decoder needs to know the matrix D. This can be a constant. Higher compression efficiency can be expected if the matrix can be optimized for the specific ambisonic signal to be compressed and the matrix transmitted as side-information.

For example, a third order ambisonic (TOA) signal contains N=16 channels. For this setup, good coding results have been achieved using a projection approach corresponding to so-called ambisonic encoding/decoding using virtually placed loudspeakers. In this transformation, the decoding matrix contains the spherical harmonic coefficients of M placed sound sources on a sphere with a unit radius.

The coefficient at row i and column k of the N-by-M decoding projection matrix D={D_{i,k}} is given by

D_{i,k}=Yₙ^{m}(φᵢ,ϑᵢ).

where φᵢ is the azimuth and ϑᵢ is the elevation of source i. The ambisonic signal ordering, k, is following the ACN convention k=n²+n+m, thus m and n are given by

n=└\sqrt{k}┘,m=k−n²−n.

The spherical harmonic for a source at (φ,ϑ) is given by

$${Y}_{n}^{m} ( ϕ , ϑ ) = {N}_{n}^{\vert m \vert} {P}_{n}^{\vert m \vert} ( sin ϑ ) \{ \begin{matrix}sin ( \vert m \vert ϕ ) & for m < 0 \\ cos ( \vert m \vert ϕ ) & for m \geq 0\end{matrix} ,$$

where Pₘ^{|m|} is the generalized Legendre function and

$${N}_{n}^{\vert m \vert} = \sqrt{\frac{2 - {δ}_{m}}{4 π} \frac{( n - \vert m \vert ) !}{( n + \vert m \vert ) !}}$$

is a normalization term.

In this implementation, the M-by-N encoding matrix E is related to the N-by-M decoding matrix D through the relation E=D⁺, i.e, E is the Moore-Penrose pseudoinverse of the decoding matrix D. Furthermore, in this implementation, the loudspeaker positions are paired up by distance so that consecutive pairs of columns in the encoding matrix E correspond to loudspeakers close to each other. By this arrangement the compression benefits of Opus stereo encoding are utilized.

In some implementations, the memory 126 can be any type of memory such as a random-access memory, a disk drive memory, flash memory, and/or so forth. In some implementations, the memory 126 can be implemented as more than one memory component (e.g., more than one RAM component or disk drive memory) associated with the components of the server computing device 120. In some implementations, the memory 126 can be a database memory. In some implementations, the memory 126 can be, or can include, a non-local memory. For example, the memory 126 can be, or can include, a memory shared by multiple devices (not shown). In some implementations, the memory 126 can be associated with a server device (not shown) within a network and configured to serve the components of the server computing device 120.

The components (e.g., modules, processing units 124) of the server computing device 120 can be configured to operate based on one or more platforms (e.g., one or more similar or different platforms) that can include one or more types of hardware, software, firmware, operating systems, runtime libraries, and/or so forth.

The components of the server computing device 120 can be, or can include, any type of hardware and/or software configured to process attributes. In some implementations, one or more portions of the components shown in the components of the server computing device 120 in FIG. 1 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the server computing device 120 can be, or can include, a software module configured for execution by at least one processor (not shown). In some implementations, the functionality of the components can be included in different modules and/or different components than those shown in FIG. 1.

Although not shown, in some implementations, the components of the server computing device 120 (or portions thereof) can be configured to operate within, for example, a data center (e.g., a cloud computing environment), a computer system, one or more server/host devices, and/or so forth. In some implementations, the components of the server computing device 120 (or portions thereof) can be configured to operate within the network 180. Thus, the components of the server computing device 120 (or portions thereof) can be configured to function within various types of network environments that can include one or more devices and/or one or more server devices. For example, the network 180 can be, or can include, a local area network (LAN), a wide area network (WAN), and/or so forth. The network 180 can be, or can include, a wireless network and/or wireless network implemented using, for example, gateway devices, bridges, switches, and/or so forth. The network 180 can include one or more segments and/or can have portions based on various protocols such as Internet Protocol (IP) and/or a proprietary protocol. The network can include at least a portion of the Internet.

In some embodiments, one or more of the components of the server computing device 120 can be, or can include, processors configured to process instructions stored in a memory. For example, the sound acquisition manager 130 (and/or a portion thereof), the loudspeaker position manager 140 (and/or a portion thereof), the decoding matrix manager 150 (and/or a portion thereof), the pseudoinverse manager 160, and the encoding manager 170 (and/or a portion thereof) can be a combination of a processor and a memory configured to execute instructions related to a process to implement one or more functions.

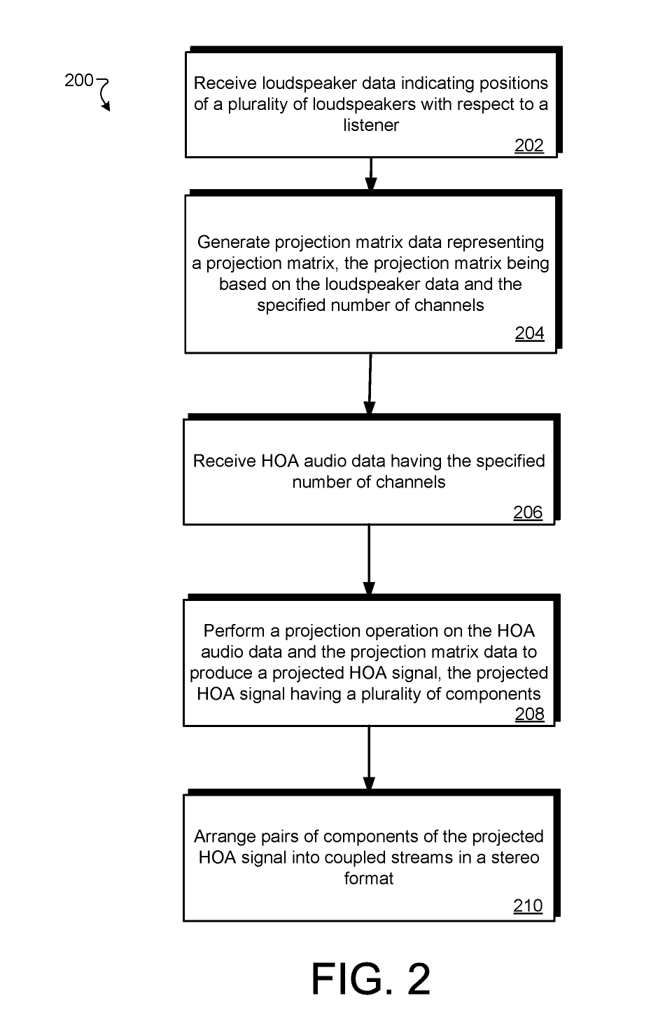

FIG. 2 is a flow chart that illustrates an example method 200 of performing binaural rendering of sound. The method 200 may be performed by software constructs described in connection with FIG. 1, which reside in memory 126 of the point cloud compression computer 120 and are run by the set of processing units 124.

At 202, controlling circuitry of the server computer 120 configured to encode high-order ambisonic (HOA) audio data having a specified number of channels receives loudspeaker data indicating positions of a plurality of loudspeakers with respect to a listener. In some implementations, the controlling circuitry may receive such loudspeaker data (e.g., loudspeaker position data 142) from output of a process that generates the loudspeaker positions according to a spherical packing over the unit sphere, e.g., such that the loudspeaker positions maximize the minimum distance between any pair of loudspeaker positions.

At 204, the controlling circuitry generates projection matrix data representing a projection matrix, the projection matrix being based on the loudspeaker data and the specified number of channels. In some arrangements, the controlling circuitry generates such projection matrix data (e.g, encoding matrix data 162) by forming a decoding matrix as described above (e.g., decoding matrix data 152) and then performing a pseudoinverse operation on the decoding matrix.

At 206, the controlling circuitry receives HOA audio data having the specified number of channels. In some implementations, the HOA audio data may be received via a direct connection to media storing previously recorded HOA audio data or via a connection to a source recording the HOA audio data in real time.

At 208, the controlling circuitry performs a projection operation on the HOA audio data and the projection matrix data to produce a projected HOA signal, the projected HOA signal having a plurality of components.

At 210, the controlling circuitry arranges pairs of components of the projected HOA signal into coupled streams in a stereo format. In some implementations, the controlling circuitry arranges the components into pairs whose components are as similar as possible, i.e., for maximum coding efficiency. In some implementations, the controlling circuitry arranges the components into pairs of consecutive components. In some implementations, the controlling circuitry encodes each pair of coupled streams into the Opus encoding.

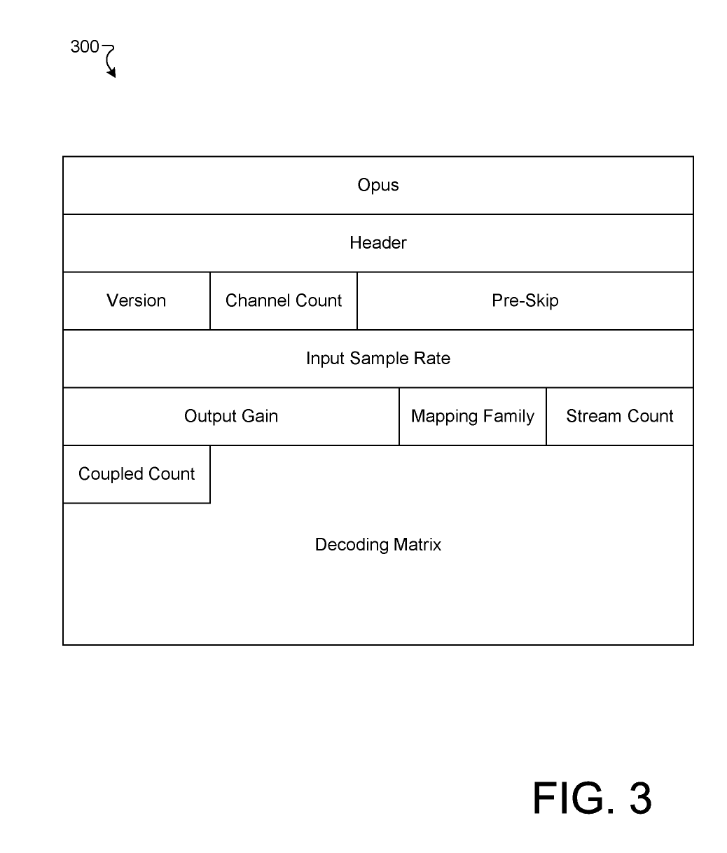

FIG. 3 is a diagram illustrating an example Ogg file format 300 used to decode Opus-encoded stereo audio into HOA ambisonics according to the improved techniques described herein. Such a file may contain the decoding matrix data 162 described with respect to FIG. 1. The example file format 300 illustrated in FIG. 3 assumes a 32-bit word length, although other word lengths are possible (e.g., 8-bit, 16-bit, 32-bit, 128-bit, 256-bit, etc.).

In the example file format 300, the following entries are present in the conventional approaches as well as the improved techniques. The first two words (64 bits) is an 8-octet field that identifies the file as an Ogg header encapsulated by an Opus codec (“Ogg Opus”) and is human readable. Version is an 8-bit, unsigned number representing a version number of a version of an encapsulation specification. In some implementations, the version number takes the value “1” to prevent a machine from relying on this octet as a null terminator for the 8-octet Ogg header. Channel Count is an 8-bit, unsigned number representing a number of output channels. Pre-skip is a 16-bit, unsigned little endian representing the number of samples at 48 kHz to discard from the decoder output when starting playback. Input Sample Rate is a 32-bit, unsigned little endian representing the sample rate of an original input in Hz before encoding. Output Gain is a 16-bit, signed little endian representing a gain to be applied when decoding.

In addition to the entries described above, the following entries are introduced in the file format 300 with regard to the improved techniques described herein. Stream Count is an 8-bit unsigned number representing the total number of streams encoded in each Ogg packet. Coupled Stream is an 8-bit unsigned number representing the number of streams whose decoders are configured to produce two (stereo) channels. Decoding Matrix is, for each of the number of channels N times the number of loudspeakers M of elements, a 16-bit signed little endians representing a decoding matrix element as described above with regard to FIG. 1.

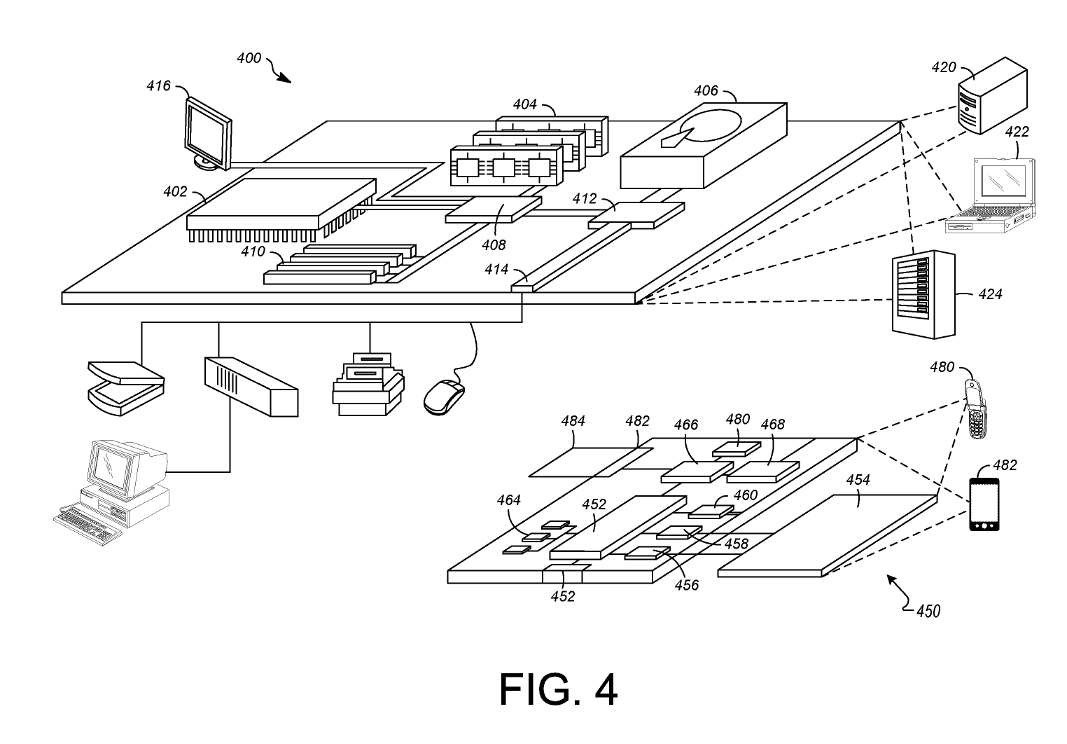

FIG. 4 illustrates an example of a generic computer device 400 and a generic mobile computer device 450, which may be used with the techniques described here.

As shown in FIG. 4, computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a volatile memory unit or units. In another implementation, the memory 404 is a non-volatile memory unit or units. The memory 404 may also be another form of computer-readable medium, such as a magnetic or optical disk.

The storage device 406 is capable of providing mass storage for the computing device 400. In one implementation, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of functions is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can execute instructions within the computing device 450, including instructions stored in the memory 464. The processor may be implemented as a chipset of chips that include separate and multiple analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD (Thin-Film-Transistor Liquid Crystal Display) or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication in some implementations, or for wireless communication in other implementations, and multiple interfaces may also be used.

The memory 464 stores information within the computing device 450. The memory 464 can be implemented as one or more of a computer-readable medium or media, a volatile memory unit or units, or a non-volatile memory unit or units. Expansion memory 474 may also be provided and connected to device 450 through expansion interface 472, which may include, for example, a SIMM (Single In Line Memory Module) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provided as a security module for device 450, and may be programmed with instructions that permit secure use of device 450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452, that may be received, for example, over transceiver 468 or external interface 462.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS (Global Positioning System) receiver module 470 may provide additional navigation- and location-related wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smart phone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite exemplary relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method, comprising:
receiving, by processing circuitry of a server computing device configured to encode high-order ambisonic (HOA) audio data having a specified number of channels, loudspeaker data indicating positions of a plurality of loudspeakers with respect to a listener;
generating, by the processing circuitry, projection matrix data representing a projection matrix, the projection matrix being based on the loudspeaker data and the specified number of channels;
receiving, by the processing circuitry, HOA audio data having the specified number of channels;
performing, by the processing circuitry, a projection operation on the HOA audio data and the projection matrix data to produce a projected HOA signal, the projected HOA signal having a plurality of components; and
arranging, by the processing circuitry, pairs of components of the projected HOA signal into coupled streams in a stereo format.

2. The method as in claim 1, wherein generating the projection matrix data based on the loudspeaker data and the specified number of channels includes:
forming decoding matrix data representing a decoding matrix by which a plurality of coupled streams in stereo format are decoded to produce the HOA audio data; and
performing a pseudoinverse operation on the decoding matrix data to produce, as the projection matrix, the Moore-Penrose pseudoinverse of the decoding matrix.

3. The method as in claim 2, wherein forming the decoding matrix data representing the decoding matrix includes, for each element of the decoding matrix:
generating a spherical harmonic function evaluated at a point on the unit sphere according to the position of the loudspeaker of the plurality of loudspeakers indicated by the row of the decoding matrix, the spherical harmonic function having an order indicated by the column of the decoding matrix.

4. The method as in claim 2, further comprising:
transmitting the coupled streams and the decoding matrix data to a user device over a network, the user device being configured to generate the HOA audio data from the coupled streams and the decoding matrix.

5. The method as in claim 1, wherein the number of the plurality of loudspeakers is greater than or equal to the specified number of channels.

6. The method as in claim 1, wherein the positions of the plurality of loudspeakers are distributed according to a spherical packing over the unit sphere.

7. The method as in claim 1, wherein arranging the pairs of components of the projected HOA signal into the coupled streams in a stereo format includes forming, as a pair of components, a pair of consecutive components of the projected HOA signal.

8. A computer program product comprising a nontransitive storage medium, the computer program product including code that, when executed by processing circuitry of a server computing device configured to encode high-order ambisonic (HOA) audio data having a specified number of channels, causes the processing circuitry to perform a method, the method comprising:
receiving loudspeaker data indicating positions of a plurality of loudspeakers with respect to a listener;
generating projection matrix data representing a projection matrix, the projection matrix being based on the loudspeaker data and the specified number of channels;
receiving HOA audio data having the specified number of channels;
performing a projection operation on the HOA audio data and the projection matrix data to produce a projected HOA signal, the projected HOA signal having a plurality of components; and
arranging pairs of components of the projected HOA signal into coupled streams in a stereo format.

9. The computer program product as in claim 8, wherein generating the projection matrix data based on the loudspeaker data and the specified number of channels includes:
forming decoding matrix data representing a decoding matrix by which a plurality of coupled streams in stereo format are decoded to produce the HOA audio data; and
performing a pseudoinverse operation on the decoding matrix data to produce, as the projection matrix, the Moore-Penrose pseudoinverse of the decoding matrix.

10. The computer program product as in claim 9, wherein forming the decoding matrix data representing the decoding matrix includes, for each element of the decoding matrix:
generating a spherical harmonic function evaluated at a point on the unit sphere according to the position of the loudspeaker of the plurality of loudspeakers indicated by the row of the decoding matrix, the spherical harmonic function having an order indicated by the column of the decoding matrix.

11. The computer program product as in claim 9, wherein the method further comprises:
transmitting the coupled streams and the decoding matrix data to a user device over a network, the user device being configured to generate the HOA audio data from the coupled streams and the decoding matrix.

12. The computer program product as in claim 8, wherein the number of the plurality of loudspeakers is greater than or equal to the specified number of channels.

13. The computer program product as in claim 8, wherein the positions of the plurality of loudspeakers are distributed according to a spherical packing over the unit sphere.

14. The computer program product as in claim 8, wherein arranging the pairs of components of the projected HOA signal into the coupled streams in a stereo format includes forming, as a pair of components, a pair of consecutive components of the projected HOA signal.

15. An electronic apparatus configured to encode high-order ambisonic (HOA) audio data having a specified number of channels, the electronic apparatus comprising:
memory; and
controlling circuitry coupled to the memory, the controlling circuitry being configured to:
receive loudspeaker data indicating positions of a plurality of loudspeakers with respect to a listener;
generate projection matrix data representing a projection matrix, the projection matrix being based on the loudspeaker data and the specified number of channels;
receive HOA audio data having the specified number of channels;
perform a projection operation on the HOA audio data and the projection matrix data to produce a projected HOA signal, the projected HOA signal having a plurality of components; and
arrange pairs of components of the projected HOA signal into coupled streams in a stereo format.

16. The electronic apparatus as in claim 15, wherein the controlling circuitry configured to generate the projection matrix data based on the loudspeaker data and the specified number of channels is further configured to:
form decoding matrix data representing a decoding matrix by which a plurality of coupled streams in stereo format are decoded to produce the HOA audio data; and
perform a pseudoinverse operation on the decoding matrix data to produce, as the projection matrix, the Moore-Penrose pseudoinverse of the decoding matrix.

17. The electronic apparatus as in claim 16, wherein the controlling circuitry configured to form the decoding matrix data representing the decoding matrix is further configured to, for each element of the decoding matrix:
generate a spherical harmonic function evaluated at a point on the unit sphere according to the position of the loudspeaker of the plurality of loudspeakers indicated by the row of the decoding matrix, the spherical harmonic function having an order indicated by the column of the decoding matrix.

18. The electronic apparatus as in claim 16, wherein the controlling circuitry is further configured to:
transmit the coupled streams and the decoding matrix data to a user device over a network, the user device being configured to generate the HOA audio data from the coupled streams and the decoding matrix.

19. The electronic apparatus as in claim 15, wherein the positions of the plurality of loudspeakers are distributed according to a spherical packing over the unit sphere.

20. The electronic apparatus as in claim 15, wherein the controlling circuitry configured to arrange the pairs of components of the projected HOA signal into the coupled streams in a stereo format is further configured to form, as a pair of components, a pair of consecutive components of the projected HOA signal.
